(19) United States
(12) Patent Application Publication
(10) Pub. No.: US 2015/0142678 A1
(43) Pub. Date: May 21, 2015

(54) METHOD AND SYSTEM FOR DETERMINING LOCATION FOR LOGISTICS INFRASTRUCTURE USING GEOGRAPHIC INFORMATION

(71) Applicant: Electronics and Telecommunications Research Institute, Daejeon (KR)

(72) Inventor: Jeong-Hun LEE, Daejeon (KR)

(73) Assignee: Electronics and Telecommunications Research Institute, Daejeon (KR)

(21) Appl. No.: 14/253,434

(22) Filed: Apr. 15, 2014

(30) Foreign Application Priority Data
Nov. 18, 2013 (KR) 10-2013-0140229

(51) Int. Cl. G06Q 50/30; G06Q 50/16; G06Q 40/00

(52) U.S. Cl. CPC G06Q 50/30; G06Q 40/10; G06Q 50/165
USPC 705/315

(57) ABSTRACT

The present invention relates to a system for determining a location for logistics infrastructure using geographic information, including: a geographic information module configured to convert the received text information into geographic information based on geo coding; a geographic information analysis module configured to extract the background information on an area including at least one of the logistics infrastructure candidates from the geographic information database and display the extracted background information on a background map screen; and a positioning module configured to include a network forming unit and a geographic information specific unit which displays specific geographic information which is negatively affected at the location for logistics infrastructure by a specific color to enable a user to determine a location for a final logistics infrastructure candidate.

### CROSS REFERENCE TO RELATED APPLICATION

This application claims the benefit of Korean Patent Application No. 10-2013-0140229, entitled “Method And System For Determining Location For Logistics Infrastructure Using Geographic Information”, which is hereby incorporated by reference in its entirety into this application.

### BACKGROUND OF THE INVENTION

1. Technical Field

The present invention relates to a method and a system for determining a location for logistics infrastructure using geographic information.

2. Description of the Related Art

To enhance competitiveness through a logistics infrastructure, it is essential to secure a location of an economical logistics infrastructure which carries out storage, collection, and transportation functions.

As a typical method for determining a location of a logistics infrastructure, a method for determining a location based on a text in consideration of a land value of an infrastructure construction site, rental costs, a distance between the infrastructures, transportation costs, and the like has been mainly used.

Meanwhile, the related art of this is disclosed in Korean Patent Laid-Open Publication No. 2009-0053120.

The above method has problems of inefficiency due to a text input time and unreality that the surrounding environment is not considered and has a difficulty in considering exceptions, such as a natural disaster, occurring during the operation, and therefore has a difficulty in practical application.

Recently, as the environment using a variety of geographic information provided at national level is created, there is a need for a method and a system for determining a location for logistics infrastructure capable of figuring out exceptions occurring during the operation in advance by visually displaying the geographic information, such as a geological condition, a road condition, and natural disaster information of an infrastructure construction site, on a map, along with general information such as the transportation distance and the transportable equipment between the infrastructures which are used at the time of determining the location of a logistics infrastructure.

### RELATED ART DOCUMENT

### Patent Document

(Patent Document 1) Korean Patent Laid-Open Publication No. 2009-0053120 (System And Method For Designing Supply Chain Network)

### SUMMARY OF THE INVENTION

The present invention has been made in an effort to provide a system and a method for determining an optimal location for logistics infrastructure using geographic information.

According to an exemplary embodiment of the present invention, there is provided a system for determining a location for logistics infrastructure using geographic information, including: a geographic information module configured to receive text information from a general information DB including at least one of addresses, main transportation equipment, a supply quantity, a land value, rental costs, legal regulations, and a tax of logistics infrastructure candidates and convert the received text information into geographic information based on geo coding; an automatic linkage module configured to perform an interface function which is linked with map information of an authorized geographic information system so as to exchange information with the system for determining a location for logistics infrastructure; a geographic information database configured to generate and store background map information based on the geographic information converted by the geographic information module and the map information transmitted from the automatic linkage module; a geographic information analysis module configured to extract the background information on an area including at least one of the logistics infrastructure candidates from the geographic information database depending on a selected condition of a user and display the extracted background information on a background map screen; and a positioning module configured to include a network forming unit which forms and displays a network in an order in which a moving distance is minimized, based on the information analyzed by the geographic information analysis module and a geographic information specific unit which displays specific geographic information which is negatively affected at the location for logistics infrastructure by a specific color to enable a user to determine a location for a final logistics infrastructure candidate.

The geographic information DB may include natural environment information having a point type including at least one of geological condition, temperature, an amount of rainfall, and an amount of snowfall, natural disaster information including at least any one of typhoon, earthquake, and landslide, and transportation condition information including at least any one of road condition, driving restriction, chronically congested road, highway, airport, harbor, railroad transportation conditions.

The geographic information analysis module may include a visual displaying unit configured to perform a visual display function on the background map screen using at least any one of point, line, face, color, and thickness and a geographic information analysis unit configured to perform a function of calculating a distance and an area.

The network forming unit may display the moving distance and costs including at least any one of infrastructure construction or rental costs, transportation costs, and operation costs of the at least one logistics infrastructure candidate on the background map screen based on the information analyzed by the geographic information analysis module.

The positioning module may further include a simulation unit configured to perform a function of forming the network information on the at least one logistics infrastructure candidate, selecting and displaying only the geographic information to be considered to select the location for logistics infrastructure designated by the user, and outputting the display screen stepwise so as to simultaneously evaluate the at least one logistics infrastructure candidate.

The specific geographic information may be at least any one of an area affected by an earthquake having a predetermined strength or more, a flimsy ground area, and an area having a high landslide occurrence frequency.

According to another exemplary embodiment of the present invention, there is provided a method for determining a location for logistics infrastructure using a system for determining a location for logistics infrastructure using geographic information, the method including: a) outputting a basic background map screen for an area selected as an area range in which a user installs the logistics infrastructure; b) selecting and receiving at least one logistics infrastructure candidate from the background map screen; c) receiving and displaying at least one basic information capacity, rental costs, a tax, and legal regulations of logistics infrastructure for the logistics infrastructure candidate on the background map screen; d) selecting and receiving a geographic information condition including at least any one of natural environment, a natural disaster, and a transportation condition to be considered to install the logistics infrastructure on the background map screen; e) outputting information on the selected geographic information condition on the background map screen; f) after step e), receiving information on exclusion or addition from or to the logistics infrastructure candidate; and g) determining remaining candidates as a final logistics infrastructure candidate when the additional logistics infrastructure candidate is not input in step f).

In step e) of outputting the information on the geographic information condition, the system for determining a location for logistics infrastructure may perform a visual display on the background map screen of the selected area using colors for at least any one of a point, a line, and a face and calculate the area of the selected point using a distance logistics infrastructure positioning method and displays and outputs the calculated area on the screen.

In step e) of outputting the information on the geographic information condition, the system for determining a location for logistics infrastructure may designate and display an area having bad selection condition of logistics infrastructure location including at least any one of a flimsy ground area, an area having a high landslide occurrence frequency, and a chronically congested road on the background map screen of the selected area by a red color.

The method for determining a location for logistics infrastructure using a system for determining a location for logistics infrastructure using geographic information may further include: prior to step g), controlling the system for determining a location for logistics infrastructure to form and output network information on the at least one logistics infrastructure candidate, select and output only the geographic information to be considered to select the location for logistics infrastructure, and output the display screen stepwise so as to simultaneously evaluate the at least one logistics infrastructure candidate.

### BRIEF DESCRIPTION OF THE DRAWINGS

FIG. 1 is a block diagram of a system for determining a location for logistics infrastructure using geographic information according to an exemplary embodiment of the present invention.

FIG. 2 is a flow chart illustrating a method for determining a location for logistics infrastructure using the system for determining a location for logistics infrastructure using geographic information according to the exemplary embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail in a detailed description. However, it is to be understood that the present invention is not limited to a specific exemplary embodiment, but includes all modifications, equivalents, and substitutions without departing from the scope and spirit of the present invention. Further, when it is determined that the detailed description of the known art related to the present invention may obscure the gist of the present invention, the detailed description thereof will be omitted.

Terms used in the specification, ‘first’, ‘second’, etc., may be used to describe various components, but the components are not to be construed as being limited to the terms. That is, the terms are used to distinguish one component from another component.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Hereinafter, exemplary embodiments of the present invention will be described in detail with reference to the accompanying drawings.

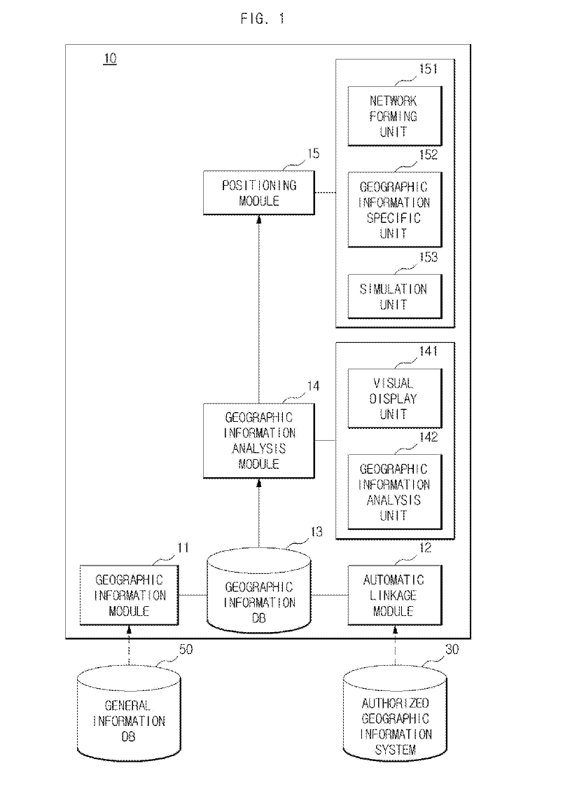

FIG. 1 is a block diagram of a system for determining a location for logistics infrastructure using geographic information according to an exemplary embodiment of the present invention.

Referring to FIG. 1, a system 10 for determining a location for logistics infrastructure using geographic information according to an exemplary embodiment of the present invention is configured to include a geographic information module 11, an automatic linkage module 12, a geographic information DB 13, a geographic information analysis module 14, and a positioning module 15.

According to the exemplary embodiment of the present invention, the geographic information module 11 performs a function of receiving textualized information from a general information DB 50, converting the received information into geographic information based on geo coding, and inputting the converted geographic information to the geographic information DB. The general information DB 50 includes addresses, main transportation equipment, a supply quantity, a land value, rental costs, legal regulations, a tax, and the like of logistics infrastructure candidates.

The automatic linkage module 12 includes interface equipment which may exchange information with the geographic information DB 13 from various types of published authorized geographic information system (national spatial information clearinghouse server 30) and performs an interface function which may automatically link the geographic information to store the geographic information on the corresponding area in the geographic information DB 13 in real time.

According to the exemplary embodiment of the present invention, the automatic linkage module 12 basically performs a function of linking administrative district information and road information with the authorized geographic information server 30 so as to generate a background map in the geographic information DB 13. Further, the geographic information DB 13 generates, upgrades, and stores at least one information of natural environment (geological condition, temperature, an amount of rainfall, an amount of snowfall), a natural disaster (typhoon, earthquake, landslide), transportation conditions (road condition, driving restriction, chronically congested road, highway, airport, harbor, railroad), and the like, in the eup, myeon, and dong unit and in the point type in real time by using the automatic linkage module 12.

The geographic information analysis module 14 includes a visual display unit 141 configured to perform a function of extracting a background map screen from the constructed geographic information DB 13 depending on the selected condition and perform a visual display function of the geographic information on the extracted background map screen using point/line/face, color/thickness, and the like and a geographic information analysis unit 142 configured to perform a function of calculating a distance and an area.

The positioning module 15 is configured to include a network forming unit 151, a geographic information specific unit 152, and a simulation unit 153.

The network forming unit 151 performs a function of forming and displaying an optimal network for logistics infrastructure candidates in an order in which a moving distance is minimized, based on the information analyzed by the geographic information analysis unit 142.

According to the exemplary embodiment of the present invention, the network forming unit 151 may display the moving distance and costs (infrastructure construction or rental costs, transportation costs, and operation costs) of each of the logistics infrastructure candidates on the map screen using a pop-up window screen, based on the information on the at least one logistics infrastructure candidates analyzed by the geographic information analysis module 14.

The geographic information specific unit 152 performs a function of displaying the geographic information, such as the natural environment, the natural disaster, and the transportation condition, in the eup, myeon, and dong unit or the point type unit around the logistics infrastructure candidates, on the map screen.

According to the exemplary embodiment of the present invention, the geographic information specific unit 152 may select and display only the referenced elements and may specify elements, which have a bad effect on the infrastructure positioning, by separate colors.

For example, an area affected by an earthquake having a predetermined strength or more, a flimsy ground area, an area having a high landslide occurrence frequency, and the like may be automatically represented stepwise by a red color.

According to the exemplary embodiment of the present invention, a user (decision-maker) may select an area range which is to be excluded from the logistics infrastructure candidates displayed on the map screen by using the geographic information specific unit 152.

The simulation unit 153 performs a function of forming the network information on various logistics infrastructure candidates, selecting and displaying only the geographic information from a variety of geographic information, and outputting the display screen stepwise so as to simultaneously evaluate several logistics infrastructure candidates.

By this, the evaluation on the existing infrastructure point may also be performed.

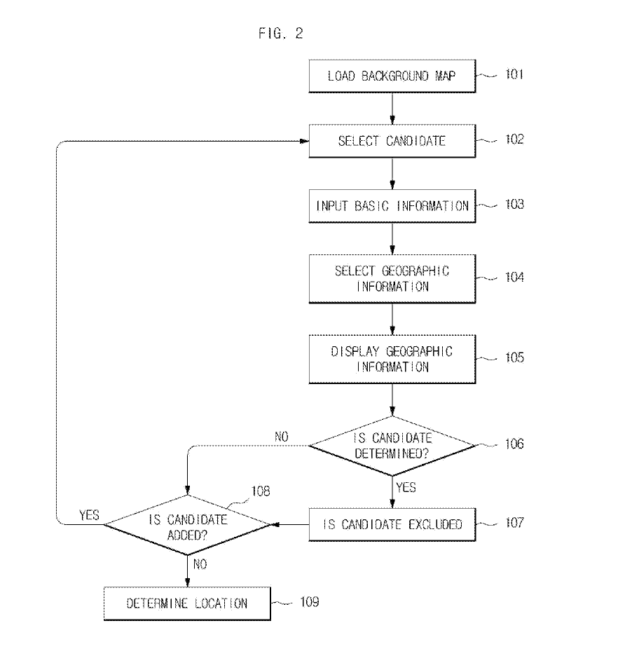

FIG. 2 is a flow chart illustrating a method for determining a location for logistics infrastructure using the system for determining a location for logistics infrastructure using geographic information according to the exemplary embodiment of the present invention.

Referring to FIG. 2, when the user first selects an area range, in which the logistics infrastructure is installed, by using the logistics infrastructure positioning system 10 in loading the background map (step 101), the logistics infrastructure positioning system loads a basic background map (administrative district area, road) for the corresponding area from the geographic information DB 13 and outputs the loaded background map on the screen.

As described above, the geographic information DB 13 generates, upgrades, and stores the information, such as the natural environment (geological condition, temperature, an amount of rainfall, an amount of snowfall), the natural disaster (typhoon, earthquake, landslide), the transportation conditions (road condition, driving restriction, chronically congested road, highway, airport, harbor, railroad), in the eup, myeon, and dong unit and in the point unit in real time by using the automatic linkage module 12.

Next, in selecting the candidates (step 102), the user may select the logistics infrastructure candidates by using a method for selecting at least one location of candidates in which the logistics infrastructures are installed from the background map screen or inputting the selected location on the background map screen by using the address information.

That is, in the selecting of the candidates (step 102), at least one candidate is selected and input from the background map screen.

After the selecting of the candidates (step 102), inputting the basic information (step 103) is performed.

In the inputting of the basic information (step 103), the capacity, rental costs, tax, legal regulations, and the like of logistics infrastructure may be input, the basic information on the candidates analyzed by the geographic information analysis module 14 may be displayed on the background map screen, and the basic information may be selectively input using the displayed basic information.

Next, selecting the geographic information (step 104) is performed.

In the selecting of the geographic information (step 104), the geographic information to be considered to install the logistics infrastructure is selected. For example, the natural environment, the natural disaster, the transportation conditions, and the like may be selected.

After the selecting of the geographic information (step 104), the information on the geographic information conditions is output and displayed (displaying the geographic information (step 105)) on the background map screen depending on the conditions selected in the selecting of the geographic information (step 104).

According to the exemplary embodiment of the present invention, in the displaying of the geographic information (step 105), the positioning module 15 is controlled to visually display the area selected by the constructed geographic information DB 13 on the background map screen using at least one of point/line/face, color/thickness, and the like, calculate the distance, the area, and the like of the selected point, and display the calculated distance, area, and the like on the screen.

Further, colors may be designated and displayed depending on the selected conditions.

For example, the areas having the bad conditions like the flimsy ground area, the area having the high landslide occurrence frequency, and the chronically congested road, and the like are designated by a red color and thus may be automatically displayed.

Next, determining the candidates (step 106) is performed.

The determining of the candidates (step 106) may include simulating to form the network information on at least one logistics infrastructure candidate, select and display only the geographic information to be considered to select the location for logistics infrastructure from a variety of geographic information, and output the display screen stepwise so as to simultaneously evaluate several logistics infrastructure candidates.

In the determining of the candidates (step 106), the user determines whether or to exclude the corresponding candidates when the area displayed by color (for example, red) representing the bad conditions includes the logistics infrastructure candidates or the logistics infrastructure candidates are present around the area and inputs the determined result on the screen.

If it is determined in the determining of the candidates (step 106) that the corresponding candidates are excluded, in the excluding of the candidates (step 107), the corresponding candidates are excluded and adding the candidates (step 108) is performed.

Further, if it is determined in the determining of the candidates (step 106) that the candidates are additionally required, the adding of the candidates (step 108) is performed.

If it is determined in the adding of the candidates (step 108) that the candidates are added, the process again proceeds to step 102.

If it is determined in the adding of the candidates (step 108) that the candidates are not added, the currently remaining candidates are determined and input as the location for logistics infrastructure in determining the location (step 109).

According to the exemplary embodiments of the present invention, the method for determining a location for logistics infrastructure may more effectively determine the location for logistics infrastructure which may be realized in real time based on the current geography condition than the existing text based positioning method.

Further, according to the exemplary embodiments of the present invention, the system for determining a location for logistics infrastructure may visually display a variety of geographic information to enable the decision-maker to make the optimal determination by excluding the errors involved in the geographic information during the decision-making process.

In addition, it is possible to improve the decision-making speed by selecting and displaying the geographic information elements to be considered depending on the infrastructure features to exclude the unnecessary information.

The exemplary embodiment of the present invention as described above sequentially describes the process of the method for determining a location for logistics infrastructure but is just exemplified to help understand the present invention, and therefore may be implemented by various types of methods by omitting the sequence of the method or changing the sequence if necessary.

A person with ordinary skilled in the art to which the present invention pertains may variously change and modify the foregoing exemplary embodiments without departing from the scope of the present invention.

Accordingly, the embodiments disclosed in the present invention and the accompanying drawings are used not to limit but to describe the spirit of the present invention.

The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A system for determining a location for logistics infrastructure using geographic information, comprising:
a geographic information module configured to receive text information from a general information DB including at least one of addresses, main transportation equipment, a supply quantity, a land value, rental costs, legal regulations, and a tax of logistics infrastructure candidates and convert the received text information into geographic information based on geo coding;
an automatic linkage module configured to perform an interface function which is linked with map information of an authorized geographic information system so as to exchange information with the system for determining a location for logistics infrastructure;
a geographic information database configured to generate and store background map information based on the geographic information converted by the geographic information module and the map information transmitted from the automatic linkage module;
a geographic information analysis module configured to extract the background information on an area including at least one of the logistics infrastructure candidates from the geographic information database depending on a selected condition of a user and display the extracted background information on a background map screen; and
a positioning module configured to include a network forming unit which forms and displays a network in an order in which a moving distance is minimized, based on the information analyzed by the geographic information analysis module and a geographic information specific unit which displays specific geographic information which is negatively affected at the location for logistics infrastructure by a specific color to enable a user to determine a location for a final logistics infrastructure candidate.

2. The system of claim 1, wherein the geographic information DB includes natural environment information having a point type including at least one of geological condition, temperature, an amount of rainfall, and an amount of snowfall, natural disaster information including at least any one of typhoon, earthquake, and landslide, and transportation condition information including at least any one of road condition, driving restriction, chronically congested road, highway, airport, harbor, railroad transportation conditions.

3. The system of claim 1, wherein the geographic information analysis module includes a visual displaying unit configured to perform a visual display function on the background map screen using at least any one of point, line, face, color, and thickness and a geographic information analysis unit configured to perform a function of calculating a distance and an area.

4. The system of claim 1, wherein the network forming unit displays the moving distance and costs including at least any one of infrastructure construction or rental costs, transportation costs, and operation costs of the at least one logistics infrastructure candidate on the background map screen based on the information analyzed by the geographic information analysis module.

5. The system of claim 1, wherein the positioning module includes a simulation unit configured to perform a function of forming the network information on the at least one logistics infrastructure candidate, selecting and displaying only the geographic information to be considered to select the location for logistics infrastructure designated by the user, and outputting the display screen stepwise so as to simultaneously evaluate the at least one logistics infrastructure candidate.

6. The system of claim 1, wherein the specific geographic information is at least any one of an area affected by an earthquake having a predetermined strength or more, a flimsy ground area, and an area having a high landslide occurrence frequency.

7. A method for determining a location for logistics infrastructure using a system for determining a location for logistics infrastructure using geographic information, the method comprising:
a) outputting a basic background map screen for an area selected as an area range in which a user installs the logistics infrastructure;
b) selecting and receiving at least one logistics infrastructure candidate from the background map screen;
c) receiving and displaying at least one basic information capacity, rental costs, a tax, and legal regulations of logistics infrastructure for the logistics infrastructure candidate on the background map screen;
d) selecting and receiving a geographic information condition including at least any one of natural environment, a natural disaster, and a transportation condition to be considered to install the logistics infrastructure on the background map screen;
e) outputting information on the selected geographic information condition on the background map screen;
f) after step e), receiving information on exclusion or addition from or to the logistics infrastructure candidate; and
g) determining remaining candidates as a final logistics infrastructure candidate when the additional logistics infrastructure candidate is not input in step f).

8. The method of claim 7, wherein in step e) of outputting the information on the geographic information condition, the system for determining a location for logistics infrastructure performs a visual display on the background map screen of the selected area using colors for at least any one of a point, a line, and a face and calculates the area of the selected point using a distance logistics infrastructure positioning method and displays and outputs the calculated area on the screen.

9. The method of claim 7, wherein in step e) of outputting the information on the geographic information condition, the system for determining a location for logistics infrastructure designates and displays an area having bad selection condition of logistics infrastructure location including at least any one of a flimsy ground area, an area having a high landslide occurrence frequency, and a chronically congested road on the background map screen of the selected area by a red color.

10. The method of claim 7, further comprising: prior to step g), controlling the system for determining a location for logistics infrastructure to form and output network information on the at least one logistics infrastructure candidate, select and output only the geographic information to be considered to select the location for logistics infrastructure, and output the display screen stepwise so as to simultaneously evaluate the at least one logistics infrastructure candidate.
